(19) United States
(12) Patent Application Publication
(10) Pub. No.: US 2007/0200478 A1
(43) Pub. Date: Aug. 30, 2007

(54) Field Emission Device

(75) Inventors: Jean Dijon, Champagnier (FR); Bruno Mourey, Coublevie (FR); Jean-Frederic Clerc, Brue en Augannes (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, PARIS (FR)

(21) Appl. No.: 10/581,485

(22) PCT Filed: Nov. 30, 2004
(86) PCT No.: PCT/FR04/50632

§ 371 Date: Jun. 2, 2006

(30) Foreign Application Priority Data
Dec. 2, 2003 (FR) 03 50953

(51) Int. Cl. H01J 1/00; H01J 63/04

(52) U.S. Cl. 313/311; 313/495

(57) ABSTRACT

A field emission device including a cathode, a porous insulating layer, of which the pores contain electron emitters, and a conductive layer as a gate layer.

### PRIOR ART

This invention relates to the production of “microtriode” devices, as well as the production of field-emission electron sources.

Planar electron sources have numerous applications, such as screens or electron sources for photolithography. The structures used to extract the electrons are of two types. These are:
collective structures, i.e. a set 3 of emitters, are controlled by a common electrode. This electrode is either the gate 8 for controlling a triode structure 6 (FIG. 1, in which references 5 and 7 respectively designate a cathode and an anode), or the anode 10 of a diode system 12 (FIG. 2, reference 13 designating a cathode), or
individual triode structures, in which each emitter 14 is controlled by an individual gate 16 (FIG. 3, with cathode 15 and anode 17).

In the first type, the emitters are coupled. The maximum density of emitters capable of functioning is on the order of 1/h² where h is the height of the nanotube. Therefore, it is possible to obtain an arbitrarily high density of emitters functioning on the surface only if h is very small, which leads to prohibitive electronic emission thresholds (the threshold is proportional to the ratio of height to radius of the nanotube).

In the second case, each emitter is isolated in a cavity. The density of the emitters is therefore set by the size of the basic device that can be produced. The limit is provided by the photolithography devices used. The higher the resolution, the smaller the surface of the producible device is and the more expensive the device is.

For applications such as high-resolution photolithography, it would be advantageous to have electron sources with a high emitter density, in order to produce an electron emitting mask as described in the patent of Wong Bong Choi (US 2002 0182542). This patent application discloses the use of carbon emitters in a diode structure. Therefore, the emitters are all coupled, with the disadvantages described above. In addition, there is no system enabling the emission of individual emitters to be controlled. Moreover, good uniformity of emission is difficult with such a device.

The goal of the invention is to propose a new type of field-emission electron source.

There is also the problem of finding a new field-effect emission device structure, allowing for a high emitter density.

Another problem is that of finding a structure enabling individual emitters to be controlled, in particular when the emitter density is high.

### DESCRIPTION OF THE INVENTION

The invention relates to a matrix or an array of emitters that can be produced without using high-resolution photolithography, and therefore compatible with a large surface production and a reasonable cost.

The invention relates to a field emission device, or an electron emitting device, comprising:
a cathode,
an insulating layer containing open zones, which open zones contain electron emitters, for example nanotubes,
a conductive layer, called a gate layer.

A method according to the invention enables any lithography step to be suppressed in the production of a field emission device.

The invention also relates to a method for producing an electron emitting device or a field emission device, comprising:
the formation of a cathode, for example of titanium nitride, molybdenum, chromium or tantalum nitride,
the formation of an insulating layer with open zones,
the formation of a conductive layer, called a gate layer,

the formation of electron emitters in the open zones of the insulating layer.

The open zones can be pores, and the insulating layer is then a porous insulating layer.

A resistive layer, for example, made of amorphous silicon, can be placed between the cathode and the insulating layer, so as to obtain a uniform current emitted.

The electron emitters can be made of carbon, and the porous insulating layer can be made of alumina.

According to an embodiment, the open zones, in particular the pores, are produced by anodisation of the aluminium layer.

A catalyst, for example of nickel, or iron, or cobalt or an oxide of these materials, can be produced in the form of a layer, between the cathode and the insulating layer, or at the base of the open zones after formation thereof.

The gate layer advantageously comprises a metallic bilayer, for example palladium-chromium or palladium-molybdenum.

The invention also relates to a method for producing a field emission device, comprising:
the formation of a cathode,
the formation of a first insulating layer, then a gate layer,
the formation of a second insulating layer and open zones in this second insulating layer,
the etching of the gate layer and the insulating layer through open zones of the second insulating layer,
the formation of electron emitters, on catalyst zones, exposed at the base of the etched zones of the first insulating layer.

According to the invention, to etch a gate structure and a first insulating layer, it is possible to use, as a mask, a second insulating layer that is porous or comprising open zones. This second layer can then be removed.

### BRIEF DESCRIPTION OF THE FIGURES

FIGS. 1 to 3 show devices known from the prior art.

FIG. 4 shows an illustration of a device according to the invention.

FIGS. 5A to 5C and 6A to 6C show steps of methods for producing devices according to the invention.

FIGS. 7A to 7B, 8A to 8D and 9A to 9C show steps of other methods for producing devices according to the invention.

### DETAILED DESCRIPTION OF EMBODIMENTS OF THE INVENTION

A first device according to the invention is shown in a cross-section view in FIG. 4.

Such a device first includes, starting with a substrate 20, a first conductive layer 22, also called a cathode conductor.

A resistive layer 24 optionally ensures the regularity of the current emitted for each emitter or a certain uniformisation of the currents among neighbouring emitters.

An insulating layer 26 has open zones, which can have the form of a certain porosity of the layer 26. Emitters 29 are located in these open zones of this insulating layer.

These emitters can be nanotubes or nanofibres, made of an emitting material, for example, carbon or metal (molybdenum or palladium, for example) or of a semiconductor material (silicon, for example). The term nanotube refers to any tubular nanometric structure, solid or hollow, capable of emitting electrons. It includes, for example, nanofibres or nanowires.

Finally, a second conductive layer 28 constitutes the emitter control gate.

This emitter or electron source assembly constitutes, with an anode 17, as shown in FIG. 3, a triode structure. It is thus constituted by an assembly of nanotriodes.

This basic device can be produced collectively on a large substrate with respect to the characteristic size of each triode.

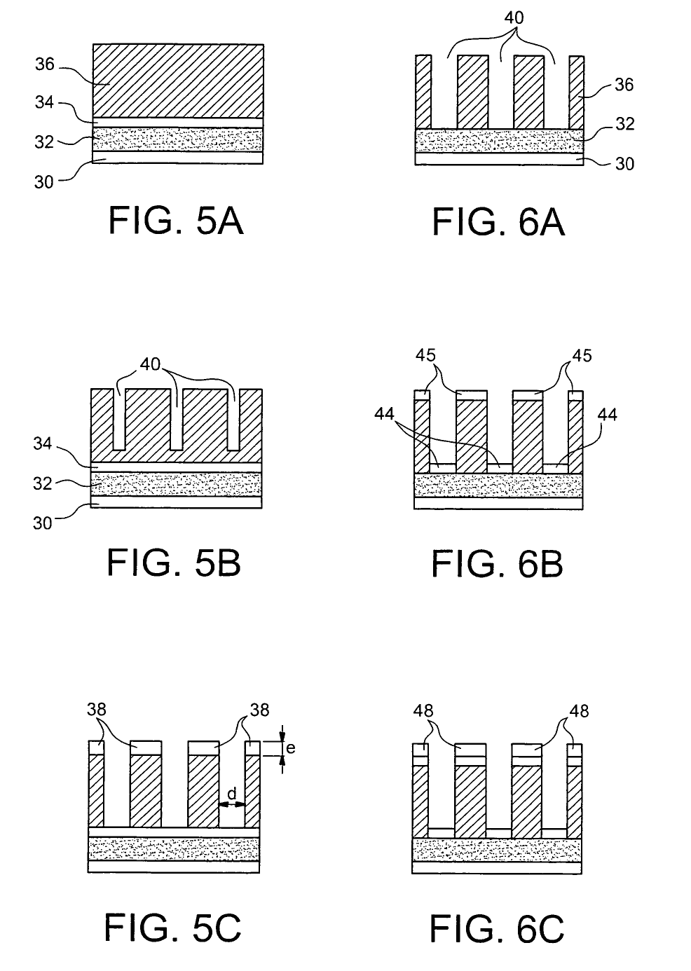

A first detailed example of an embodiment of a structure according to the invention will be provided in reference to FIGS. 5A to 5C.

A cathode conductor layer 30 is made of TiN or any other conductive material, for example molybdenum (Mo), or chromium (Cr), or tantalum nitride (TaN). The thickness of the layer is between 10 nm and 100 nm; it is, for example, on the order of 60 nm.

On this layer 30, a resistive layer 32 having a thickness, for example, between 500 nm and 1 μm, is deposited. This layer 32 is, for example, a layer of amorphous silicon, which can be deposited by cathode sputtering or by CVD. This layer makes it possible to limit the current emitted by the individual emitters so that the emission will be uniform.

On this layer 32, a catalyst layer 34, for example of nickel, iron, cobalt or an oxide layer of these materials, is deposited by evaporation. The thickness of this layer 34 is typically between 1 nm and 10 nm.

Then, an aluminium deposit 36, for example by evaporation, is produced. Its thickness is typically on the order of 100 nm to 700 nm.

This aluminium layer is anodised: an insulating layer is therefore produced by anodisation of the aluminium layer, using, for example, a two-step process as described in the publication of H. Masuda (Jpn. J. Appl. Phys. Vol. 35 (1996, pp L126-129)).

At the end of the anodisation process, pores 40 (FIG. 5B), having a diameter on the order of several nanometres, for example between 5 nm and 25 nm, are obtained.

These pores are not connected to the conductive layer 32. To make this connection (figure SC), and control the diameter of the pores, the alumina 36 is etched, for example with 5% diluted phosphoric acid.

The deposition, under oblique incidence, of the gate metal 38 (figure SC) is then performed.

To prevent the pores from being filled, the deposited thickness e is preferably on the same order of magnitude as the diameter d of the pores. To prevent this filling, it is also possible to use a metallic bilayer consisting of:
a first catalyst material such as palladium (which has a very small closing angle) and/or nickel and/or iron and/or cobalt, with a thickness, for example, between 1 nm and 20 nm,
and a second metal, such as chromium and/or molybdenum and/or copper and/or niobium, for example with a thickness between 20 nm and 100 nm, depending on the diameter of the openings of the pores or openings that are not to be filled), which does not catalyse the nanotube growth reaction.

The catalyst is then formed into drops by annealing. The catalyst at the base of the holes is thus reduced. This reduction occurs either in the presence of hydrogen partial pressure (typically several hundred mTorr), or is assisted by a hydrogen RF plasma.

The emitters are then formed, depending on the particular case, by growing nanotubes or nanofibres, for example of carbon. It is possible to use, to produce the nanotubes, either a pure catalytic growth method (for example, the deposition is performed at 600° C. in the presence of acetylene at a pressure of 100 mTorr), or a catalytic growth method with RF plasma. The deposition temperature is then typically 500° C., the RF power is 300 W, the reactive gas being a mixture H2+C2H2 with 5% acetylene, all under a total pressure of 100 mTorr.

If the growth is performed by CVD, to obtain tubes having a uniform length, an ultrasound bath is added after the deposition, in order to cut the tubes at the level of the gate.

A second example is shown in FIGS. 6A to 6C.

It is performed in substantially the same way as in example 1, but without a prior deposition of the catalyst layer: therefore, the structure of FIG. 6A is first obtained, with a cathode conductor layer 30, a resistive layer 32, and a layer 36 of aluminium, then alumina with pores 40.

A catalyst 44 is deposited by electrodeposition, after the step of opening the pores 40 in the alumina (FIG. 6B). It can also be performed by aggregate deposition, or by evaporation. This catalyst therefore forms a layer 44 at the base of the pores, as well as a layer 45 on the upper portion of the alumina layer 36, at the periphery of the openings of the pores 40. This catalyst material is, for example, palladium (which has a very small closing angle) and/or nickel and/or iron and/or cobalt, at a thickness, for example, between 1 nm and 20 nm.

A metal incidence deposition makes it possible to produce the gate 48. This covers the catalyst layer 45. The metal used is, for example, chromium and/or molybdenum and/or copper and/or niobium, for example having a thickness between 20 nm and 100 nm.

The emitters are then formed, as already described above in the first example.

In the two examples, a structure identical to that of FIG. 4 is obtained. In another alternative, it is possible, after the formation of the pores, to grow silicon wires in these pores according to known techniques. It is also possible to perform a deposition, for example, an electrochemical deposition of an emitting metal such as molybdenum, palladium or gold in order to form a metal emitter.

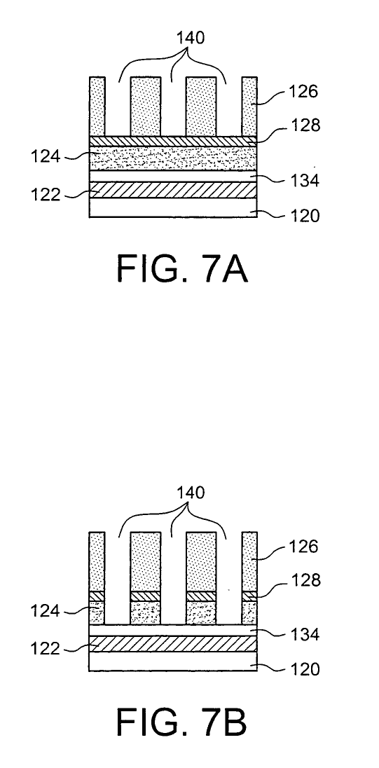

Another example of a method according to the invention will be provided in reference to FIGS. 7A and 7B.

On a substrate 120 (FIG. 7A), a cathode layer 122, optionally covered with a resistive layer, is formed.

A catalyst layer 134 is then formed on the cathode layer 122.

A first insulating layer 124 is in turn formed on the catalyst layer 134. This insulating layer is, for example, made of SiO₂, or Si₃N₄, and can have, for example, a thickness between 50 nm and 500 nm.

A conductive gate layer 128 is then formed, for example, of Mo, and/or Nb, and/or Cr and/or Cu, and, for example, having a thickness between 10 nm and 100 nm.

Finally, a second insulating layer 126, in which openings 140 or open zones are produced, for example a porous layer, is formed on the gate layer. A porous layer can be obtained by an aluminium deposit having a thickness of several hundred nm, for example between 100 nm and 700 nm, for example on the order of around 500 nm, then anodisation of this aluminium layer, which leads to the formation of pores 140.

The gate layer 128 as well as the first insulating layer 124 are etched through openings or pores 140 of the layer 126, to open onto the catalyst layer 134, for example, by plasma etching (FIG. 7B).

Nanotubes can then be formed, from the exposed catalyst zones 134.

The second insulating layer 126 can then be removed, but it can also be removed before the formation of the nanotubes. This removal is performed, for example, by a chemical attack with soda or orthophosphoric acid (H₃PO₄).

An electron-emitting device is thus obtained, having the structure of FIG. 7B, without the layer 126, with electron emitting means being arranged in the openings 140.

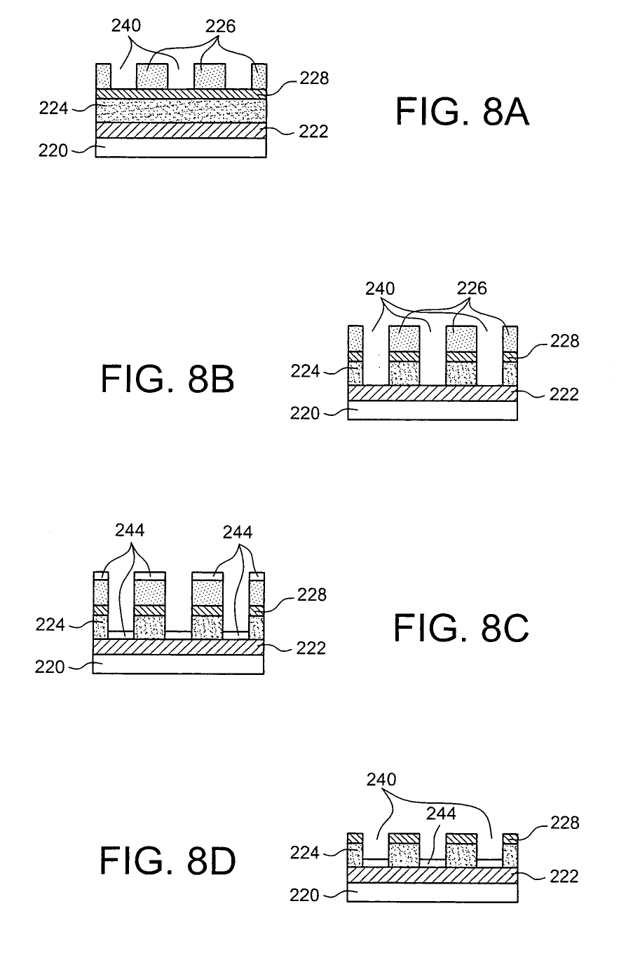

Another method according to the invention will be described in reference to FIGS. 8A to 8C.

A cathode layer 222, optionally covered with a resistive layer, is formed on a substrate 220.

A first insulating layer 224 is then formed, followed by a gate conductive layer 228 on the insulating layer.

A second insulating layer 226, in which openings 240 or open zones are produced, for example a porous layer, is then formed on the gate layer (FIG. 8B).

A porous layer can be obtained by an aluminium deposit having a thickness of several hundred nm, for example between 100 nm and 700 nm, for example, on the order of around 500 nm, then anodisation of this aluminium layer, which leads to the formation of pores 240.

The gate layer and the first insulating layer are etched through openings or pores of the layer 226, so as to open onto the cathode 222, or onto the resistive layer (FIG. 8B).

Next, a catalyst layer 244 is deposited, for example, by evaporation, or by means of an electrochemical process (FIG. 8C).

Finally, the layer 226 (FIG. 8D) is removed, for example by a soda or H₃PO₄ attack.

Nanotubes can then be formed on the remaining zones of the catalyst 244, which remaining zones are located at the base of the openings 240.

An electron-emitting device is thus obtained, having the structure of FIG. 8D, electron emitting means being arranged in the openings 240.

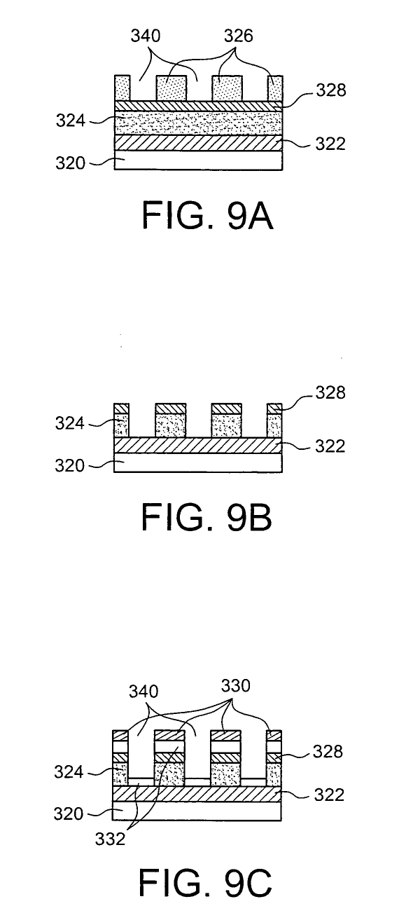

A third method will be described in reference to FIGS. 9A to 9C.

On a substrate 320, a cathode layer 322, optionally covered with a resistive layer, is formed.

A first insulating layer 324 is formed on the cathode 322, followed by a gate conductive layer 328 on said first insulating layer.

A second insulating layer 326, in which openings 340 or open zones are produced, for example a porous layer, is then formed on the gate layer (FIG. 9A).

A porous layer can be obtained by an aluminium deposit having a thickness of several hundred nm, for example between 100 nm and 700 nm, for example, on the order of around 500 nm, then anodisation of this aluminium layer, which leads to the formation of pores 340.

The gate layer 328 and the first insulating layer 324 are then etched through openings or pores of layer 326, so as to open onto the cathode 322, (FIG. 9B).

The layer 326 is then removed, for example, by a soda or H₃PO₄ attack.

A catalyst layer 332 is then deposited, for example by sputtering.

By oblique incidence deposition, a metal layer 330 is formed on the catalyst layer, so as to mask the catalyst that was deposited on the gate 328.

Nanotubes can then be formed in the exposed catalyst zones 332 (FIG. 9C).

An electron-emitting device is thus obtained, having the structure of FIG. 9C, electron emitting means being arranged in the openings 340.

In the methods described above in reference to FIGS. 7A, 7B, 8A to 8D, and 9A to 9C, the second insulating layer 126, 226, 326, in which openings or pores are produced, is used as an etching mask, before being removed.

Steps of these methods that are not specifically described were described previously in reference to FIGS. 5A to 6C. This is true in particular for the growth of emitters or nanotubes. It is also possible to grow silicon wires according to known techniques. It is also possible to perform a deposition, for example an electrochemical deposition of an emitting metal such as molybdenum, palladium or gold so as to form a metallic emitter.

The materials used for the catalyst 134, 244, 332 can be those already indicated in the examples above. The same applies to the gate conductors.

A structure according to the invention, regardless of the embodiment, makes it possible to form a device with individual emitters, but with a high density since the pores formed have a diameter on the order of several nanometres.

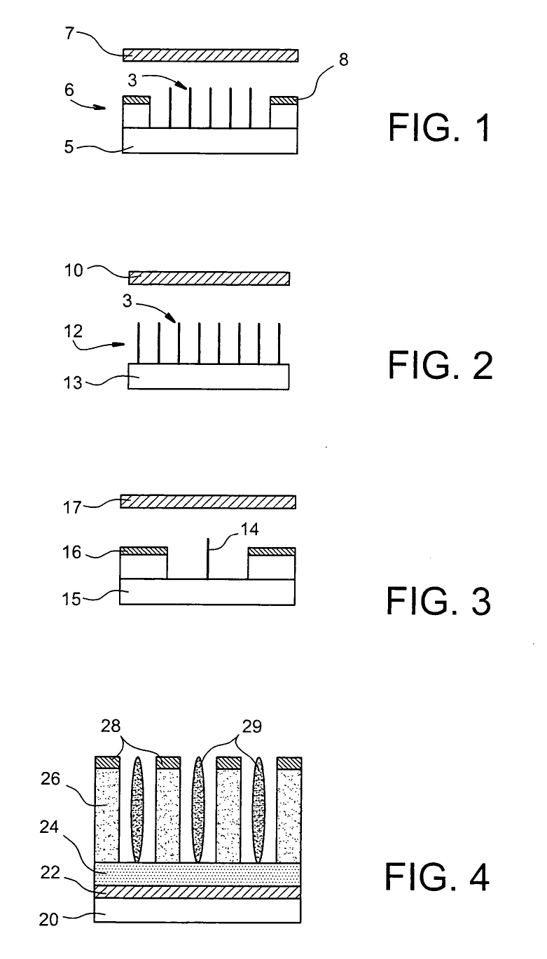

An emitting device according to the invention can be equipped with means for bringing the cathode, the gate layer and an anode, arranged as in FIG. 1, to the desired potentials.

It is typically possible to obtain nanotubes distributed at a distance of 40 nm or even less.

1-29. (canceled)

30. A field emission device, comprising:
a cathode;
a porous insulating layer includes open zones, which are pores of the layer;
a conductive layer as a gate layer, including at least one layer of catalyst material for forming electron emitters and at least one layer of a conductive material not catalyzing formation of electron emitters; and
electron emitters in the open zones of the insulating layer and the gate layer.

31. A device according to claim 30, further comprising a resistive layer arranged between the cathode and the insulating layer.

32. A device according to claim 30, wherein the electron emitters are constituted by nanotubes or nanofibers.

33. A device according to claim 30, wherein the electron emitters are made of carbon.

34. A device according to claim 30, wherein the electron emitters are made of a metallic material.

35. A device according to claim 24, wherein the electron emitters are made of molybdenum or palladium.

36. A device according to claim 30, wherein the electron emitters are made of an emitting semiconductor material.

37. A device according to claim 36, wherein the electron emitters are made of silicon.

38. A device according to claim 30, wherein the insulating layer is made of alumina.

39. A device according to claim 30, wherein the open zones or the pores have a diameter between 5 nm and 25 nm.

40. A method for producing a field emission device, comprising:
forming a cathode;
forming a porous insulating layer, including open zones that are pores in the layer;
forming a conductive layer, as a gate layer, including at least one layer of catalyst material for forming electron emitters and at least one layer of a conductive material not catalyzing formation of electron emitters; and
forming electron emitters in the open zones of the insulating layer and the gate layer.

41. A method according to claim 40, further comprising forming a resistive layer, between the cathode and the insulating layer.

42. A method according to claim 41, wherein the resistive layer is made of amorphous silicon.

43. A method according to claim 40, wherein the emitters are nanotubes or nanofibers.

44. A method according to claim 40, wherein the emitters are made of carbon.

45. A method according to claim 40, wherein the electron emitters are obtained by electrochemical deposition of an emitting metal.

46. A method according to claim 40, wherein the insulating layer, or the second insulating layer, is produced from an aluminum layer.

47. A method according to claim 40, wherein the cathode is made of titanium nitride (TiN), molybdenum, chromium, or tantalum nitride (TaN).

48. A method according to claim 40, wherein the catalyst is made of nickel, or iron or cobalt, or an oxide of these materials.

49. A method for producing a field emission device, comprising:
forming a cathode;
forming a first insulating porous layer, and then a gate layer;
forming a second insulating porous layer and open zones in the second insulating layer, the open zones being pores of the layer;
etching the gate layer and the first insulating layer, through the open zones of the first insulating layer; and
forming electron emitters, on catalyst zones, exposed at a base of the etched zones of the first insulating layer.

50. A method according to claim 49, further comprising forming a catalyst layer prior to the forming of the first insulating layer.

51. A method according to claim 50, further comprising removing the second insulating layer, before or after the forming of electron emitters.

52. A method according to claim 49, further comprising depositing, at least in the etched zones of the first insulating layer, a catalyst material, after etching of the gate layer and the first insulating layer.

53. A method according to claim 52, further comprising removing the second insulating layer, after depositing the catalyst material.

54. A method according to claim 52, further comprising removing the second insulating layer, before depositing the catalyst material, then depositing the catalyst material in the etched zones of the first insulating layer and on the non-etched zones of the gate.

55. A method according to claim 54, further comprising forming a metallic layer on the catalyst layer deposited on the gate.

56. A method according to claim 49, wherein a resistive layer, or a layer of amorphous silicon, is arranged on the cathode.

57. A method according to claim 49, wherein the emitters are nanotubes or nanofibers.

58. A method according to claim 57, wherein the nanotubes are obtained by pure catalytic growth or with RF plasma.

59. A method according to claim 49, wherein the emitters are made of carbon.

60. A method according to claim 49, wherein the electron emitters are obtained by electrochemical deposition of an emitting metal.

61. A method according to claim 49, wherein the insulating layer, or the second insulating layer, is produced from an aluminum layer.

62. A method according to claim 61, wherein the open zones or the pores are produced by anodization of the aluminum layer.

63. A method according to claim 49, wherein the cathode is being made of titanium nitride (TiN), molybdenum, chromium, or tantalum nitride (TaN).

64. A method according to claim 49, wherein the catalyst is made of nickel, or iron or cobalt, or an oxide of these materials.
